(19) United States
(12) Patent Application Publication
(10) Pub. No.: US 2019/0302731 A1
(43) Pub. Date: Oct. 3, 2019

(54) DATA STORAGE DEVICE FOR USE WITH A NUMERICALLY CONTROLLED MACHINE TOOL

(71) Applicant: DECKEL MAHO PFRONTEN GMBH, Pfronten (DE)

(72) Inventors: Rolf KETTEMER, Marktoberdorf (DE); Alexander HOLZNER, Mülheim an der Ruhr (DE); Gerhard RAUSCH, Rheda-Wiedenbrück (DE)

(73) Assignee: DECKEL MAHO PFRONTEN GMBH, Pfronten (DE)

(21) Appl. No.: 16/082,053

(22) PCT Filed: Mar. 3, 2017
(86) PCT No.: PCT/EP2017/055065

§ 371 Date: Sep. 4, 2018

(30) Foreign Application Priority Data
Mar. 3, 2016 (DE) 10 2016 203 554.1
Sep. 13, 2016 (DE) 10 2016 217 443.6

(51) Int. Cl. G05B 19/408; G05B 19/18

(52) U.S. Cl. CPC G05B 19/408; G05B 2219/35373; G05B 19/182

(57) ABSTRACT

A data storage device is used with a numerically controlled machine tool having a control device controlling machine tool actuators and sensors sending sensor signals indicating a machine state to the control device. The data storage apparatus includes: a first interface unit; a first storage medium storing configuration data indicating a group of machine tool sensors and read-out and processing rules for group sensor signals; a read-out unit reading out sensor signal values sent by the group specified in the configuration data via the first interface unit on the basis of specified read-out rules; a data processing unit processing the sensor signal values read out by the read-out unit into aggregated sensor system data on the basis of the processing rules specified in the configuration data; a second storage medium storing the sensor system data; and a second interface unit for data transmission to an external data processing unit.

The present invention relates to a data storage apparatus for use with a numerically controlled machine tool that comprises a control device for controlling a plurality of actuators of the machine tool and a plurality of sensors for sending sensor signals indicating a machine state of the machine tool to the control device.

### BACKGROUND

The prior art discloses numerically controlled machine tools, comprising a control device for controlling a plurality of actuators of the machine tool and a plurality of sensors for sending sensor signals indicating a machine state of the machine tool to the control device.

In order to evaluate, display or monitor a machine state of the machine tool during the operation or during the processing of workpieces on the machine tool, it is known to provide processor-controlled storage units (so-called data loggers) in the control device of the machine tool or connected to the control device of the machine tool, said storage units storing all available sensor signals of the sensors of the machine tool in individual channels at the same sampling frequency or read-out frequency in a storage medium, wherein the sampling frequency or read-out frequency, however, depends on the type-dependent possibilities of the control device (NC control and/or PLC) of the machine tool.

Thus, an unfiltered and unadapted flood of pure sensor value data from all available sensors is stored with data loggers known in the prior art for various machine tools, each of which is dependent on the machine tool as well as on the control system.

On the one hand, this leads to large and confusing amounts of collected data and, on the other hand, makes it particularly difficult to evaluate and/or display the collected data in a way that is independent of machine tools and/or control systems.

In view of the above mentioned problems, one object of the present invention is to provide a data storage apparatus for use with a numerically controlled machine tool capable of avoiding the above mentioned problems.

In particular, it is an object of the present invention to provide a simpler, clearer storage of sensor system data of a numerically controlled machine tool that is easier to further utilize, which also preferably reduces the data processing utilization of the machine tool controller when reading out the sensor values and is also preferably able to reduce the amount of data to be stored while maintaining a high informative value, and which is also preferably universally applicable regardless of the machine tool type and/or the controller type.

### SUMMARY

In order to achieve the above mentioned object, the invention proposes a data storage apparatus for use with a numerically controlled machine tool according to independent claim 1. Dependent claims, system claims or alternative independent claims relate to preferred embodiments of the present invention.

According to one aspect of the invention, a data storage apparatus is proposed for use with a numerically controlled machine tool, wherein the machine tool can include a control device for controlling a plurality of actuators of the machine tool and a plurality of sensors for sending sensor signals indicating a machine state of the machine tool to the control device.

The data storage apparatus can comprise: a first interface unit for transmitting data or for providing a data link to the numerical control device of the machine tool; a first storage medium for storing configuration data preferably specifying a group of machine tool sensors and read-out and/or processing rules for sensor signals of the group of machine tool sensors; a read-out unit for reading out sensor signal values of the sensor signals of the group of machine tool sensors specified in the configuration data via the first interface unit, preferably on the basis of the readout rules specified in the configuration data; a data processing unit for processing the sensor signal values read out by the read-out unit into aggregated sensor system data, preferably on the basis of the processing rules specified in the configuration data; a second storage medium for storing the aggregated sensor system data processed by the data processing unit; and/or a second interface unit for transmitting data and/or for providing a data connection to an external data processing device via which the external data processing device is allowed the access to sensor system data stored in the second storage medium.

The sensors available on the machine tool and the availability of the sensor values on the controller can vary greatly depending on the type of machine and/or controller.

For this purpose, the invention provides by way of example the modifiable determination in configuration data for reading out and processing the sensor system data, which sensors are available or are to be read out on the machine tool, and how the respective sensor values are to be read out (e.g. by defining predetermined individual read-out rates) and/or how the read-out sensor values are to be processed and stored (processing rules).

On the basis of the individually configurable configuration data, the data storage unit according to the invention can be used in a variety of ways and can be used on machines with an extensive sensor package having a large number of optional sensors, but can also be retrofitted to existing machines. Depending on the type and number of available sensors and control-dependent read-out options, the configuration data allows the configuration of the read-out function and further processing function of the data storage unit so as to be individually adapted to the respective machine and its control system or to the demand, while transmitting the sensor system data to other data processing devices via a universal interface (e.g. OPC interface, or in particular OPC UA interface, or even an MQTT interface) independent of the machine and controller.

The configuration data can, for example, be stored in a configuration file in a universal data format in a markup language (e.g. as an XML file).

For certification purposes, the configuration data can also specify the sensor signal channels that must be supplied for certification, i.e. which sensor signals and/or which events are to be stored in certification data in connection with which sensor signals.

According to a preferred aspect, the second interface unit can be configured to transmit sensor system data stored in the second storage medium to a server via a local or global network. The advantage is that sensor system data and/or certification data can be stored centrally on a local or global server (e.g. also in a cloud application) in the case of larger data volumes and over a longer period of time and can be provided for analysis.

Furthermore, this offers the advantage that sensor system data and/or certification data from a plurality of machine tools can be stored centrally on the server via the local or global network in a simple and universal way, even from very different locations, e.g. also to allow remote maintenance diagnoses or advantageous comparison analyses of the sensor data and/or certification data of different machine tools or the same machine tools used under different conditions and at different locations.

According to a preferred aspect, the data processing unit can be configured to compress and/or encrypt the sensor system data stored in the second storage medium for data transmission to the server. This has the advantage that data security during transmission is ensured and unauthorized access is prevented, as well as efficient data storage of compressed data for long-term storage on the server is ensured.

According to a preferred aspect, the second interface unit can be configured to repeatedly transmit at regular intervals sensor system data stored in the second storage medium and collected over a predetermined period of time via the local or global network to the server. In the meantime, the data can be stored in a buffering way at the data storage device (also for safety reasons to avoid data loss in the event of network problems) and this also allows simple and controlled, if necessary, automatic transmission of data in packets, e.g. at predetermined time intervals or data volumes and, if necessary, at predetermined times.

According to a preferred aspect, the sensor system data transmitted to the server can also specify a machine type of the machine tool, a machine configuration of the machine tool and/or machine identification data, which in particular comprise a machine number, of the machine tool. This has the advantage that it is easier to compare and identify the machine tool and/or the working conditions of the machine tool or machine type, especially when comparing the data of different machines in an analyzing way.

According to a preferred aspect, the second interface unit can include a web interface and/or a web service application, through which the external data processing device can preferably have access to aggregated sensor system data stored in the second storage medium via a web browser and/or a web application. The advantage is that data can be displayed and analyzed easily and efficiently via web interfaces and web browser access, so that even a large number of external data processing devices (e.g. computers, notebooks, tablets, smartphones) can easily and universally access, display and/or analyze the data using a web application and/or a link via a web browser.

According to a preferred aspect, the configuration data can also specify a data format, and the data processing unit can preferably store the aggregated sensor system data in the second storage medium in the data format specified in the configuration data. This has the advantage that a universal but also universally configurable data format is made possible, even with different machine and control configurations or sensor availabilities, so that sensor system data can be provided in a universal data format for universal access by a large number of different external data processing devices, independent of the machine and controller.

According to a preferred aspect, the second interface unit can be connectable to a man-machine interface of the control device of the machine tool, preferably for transmitting sensor system data stored in the second storage medium to the man-machine interface, preferably for display on a graphical user interface of the man-machine interface of the control device of the machine tool. This has the advantage that the sensor system data can also be displayed, read out, analyzed or viewed at a human-machine interface of the controller, so that an operator is able to display and/or analyze the sensor data and/or certification data directly at the machine tool.

According to a preferred aspect, the second storage medium can comprise a ring buffer, and the sensor system data can preferably be stored in the ring buffer. This has the advantage that after a predetermined data volume, especially after the data has been transferred to an external data processing device, data storage is available for newly collected data. The data storage volume to be made available in the ring buffer is preferably configurable, e.g. via the configuration data.

According to a preferred aspect, the data processing unit can also be configured to store sensor system data together with a corresponding time stamp in the second storage medium. The advantage is that an analysis is made possible and a data history can be recorded.

According to a preferred aspect, the read-out rules of the configuration data can specify an individual read-out frequency for one, several or all sensor signals of the group of machine tool sensors specified in the configuration data. Preferably, the read-out unit is then configured to read out sensor signal values for a corresponding sensor signal at the corresponding individual readout frequency specified in the configuration data. The advantage is that individual sensor signal read-out rates can be configured as required.

According to a preferred aspect, at least one individual read-out frequency specified in the configuration data can be lower than a sensor value memory frequency of a programmable logic controller and/or than a sensor value memory frequency of an NC control of the control device. This allows a universal read-out characteristic that is more control independent in an advantageous way.

According to a preferred aspect, the processing rules of the configuration data can specify an individual processing rule for one, several or all sensor signals of the group of machine tool sensors specified in the configuration data. Preferably, the data processing unit can then be configured to calculate a single sensor system value for a corresponding sensor signal from a plurality of sensor signal values read out over a period of time specified in the individual processing rule by means of the corresponding individual processing rule specified in the configuration data and to store it in the second storage medium. This has the advantage that processing rules can be configured as required but also to reduce the data volume to be stored, e.g. by aggregating a plurality of signal values of a sensor to one signal value to be stored.

According to a preferred aspect, an individual processing rule can specify that the sensor system value is to be calculated as the average of the plurality of sensor signal values read out over a period of time specified in the individual processing rule, and/or an individual processing rule can specify that the sensor system value is to be calculated as the maximum value or minimum value of the plurality of sensor signal values read out over a period of time specified in the individual processing rule.

According to a preferred aspect, the processing rules of the configuration data can specify a combination rule for at least two sensor signals of the group of machine tool sensors specified in the configuration data. The data processing unit can then be configured to calculate a combined sensor system value for sensor values of the at least two sensor signals on the basis of the combination rule and store it in the second storage medium. The advantage is that processing rules can be configured as required but also to reduce the data volume to be stored, e.g. by combining a plurality of signal values of several sensors into one signal value to be stored (e.g. concerning several sensor signals concerning the same machine component).

According to a preferred aspect, the configuration data can comprise certification rules for one, several or all sensor signals of the group of machine tool sensors specified in the configuration data. The data processing unit can also be configured to generate certification data on the basis of the certification rules specified in the configuration data and on the basis of the corresponding read-out sensor signals, and to store the generated certification data in the second storage medium. Preferably, access to certification data stored in the second storage medium can be granted via the second interface unit of the external data processing device. The advantage is that sensor system data storage can be combined with a possibly necessary certification of the processes in a simple and efficient manner. Therefore, the certification does not have to be carried out subsequently on the basis of the stored sensor system data.

According to a preferred aspect, the certification data can specify when and/or at which position of an NC program executed on the control device of the machine tool one or more of the sensor signals specified in the certification rules has exceeded a corresponding limit value. Alternatively or additionally, e.g. if no limit value was exceeded, it can be stated that none of the sensor signals specified in the certification rules exceeded the corresponding limit value during a predetermined period of time or during the execution of the NC program.

According to a preferred aspect, the second interface unit can be configured to allow the external data processing device access to configuration data stored in the first storage medium, in particular preferably to modify the configuration data. The advantage is that the configuration data can be configured as required, e.g. if other or additional read-out or processing rules are to be set, or also if the machine is retrofitted with sensors or the controller is extended.

According to a preferred aspect, the configuration data for one, several or all sensor signals of the group of machine tool sensors specified in the configuration data can specify one or several individual limit values. The data processing unit can be configured to store associated limit values specified in the configuration data in the second storage medium for calculated sensor system values. This facilitates the subsequent analysis of the data since the corresponding limit value is also stored.

According to a preferred aspect, the readout unit can also be configured to read out counter reading values from registers of a programmable logic controller of the machine tool control device via the first interface unit.

According to a preferred aspect, the data processing unit can also be configured to store read-out counter reading values in the second storage medium, in particular preferably together with a time stamp.

According to a preferred aspect, the readout unit can comprise a data logger.

According to a secondary aspect, a system can also be provided, which has a data storage apparatus according to one or more of the above aspects and which has an external data processing device which is preferably connected to the second interface unit via a local or global network. The external data processing device (e.g. a server) can be preferably configured to access sensor system data stored in the second storage medium and/or configuration data stored in the first storage medium via the second interface unit.

Further aspects and the advantages thereof as well as advantages and more specific implementation options of the above described aspects and features are described in the following descriptions and explanations of the attached figures, which are, however, in no way restrictive.

### BRIEF DESCRIPTION OF THE DRAWINGS

FIG. 1 shows an exemplary schematic diagram of a system with a data storage apparatus according to an embodiment of the invention,

FIG. 2 shows an exemplary schematic diagram of a system according to a further embodiment of the invention, and

FIG. 3 shows an exemplary schematic diagram of a system according to a further embodiment of the invention.

### DETAILED DESCRIPTION OF THE DRAWINGS AND PREFERRED EMBODIMENTS

In the following, examples or embodiments of the present invention are described in detail with reference to the attached drawings. Identical or similar elements in the drawings can be designated with the same reference signs, but sometimes also with different reference signs.

It should be pointed out, however, that the present invention is in no way limited or restricted to the below described embodiments and the design features thereof, but continues to comprise modifications of the embodiments, in particular those which are covered by modifications of the features of the described examples or by combining one or more of the features of the described examples within the scope of protection of the independent claims.

According to the invention, a data storage apparatus for use on a numerically controlled machine tool and in optional connection to external data processing devices (e.g. server, computer, PC, notebook, tablet and/or smartphone) or in optional connection to external data networks (LAN, WAN, Intranet, and/or Internet) is proposed in embodiments, wherein the machine tool comprises control device (e.g. NC and/or PLC) for controlling a plurality of actuators of the machine tool and a plurality of sensors for sending sensor signals indicating a machine state of the machine tool to the control device.

This allows an improved condition monitoring, i.e. e.g. permanent and/or regular acquisition of machine process data (e.g. of temperatures, loads, vibrations) from corresponding machine tool sensors to determine the machine state (e.g. the current machine state, an average machine state, a machine state at a previous point in time or in a previous period, or also a machine state at peak machining times in the limit range).

By means of subsequent calculations and analyses of this determined data, changes in the entire machine or individual assemblies can be derived to dynamically adjust e.g. service intervals (“predictive maintenance”). In addition, the determined process data offers the operator, user or the company using the machine tool the possibility to optimize the processing of workpieces on the machine tool through greater transparency.

Ordering and/or delivery processes can also be triggered directly and automatically in this case if the need is determined on the basis of data evaluation (e.g. by remote diagnosis on an evaluation server) that maintenance or spare parts installation or replacement on a particular machine tool is required. In addition, when or after it is determined that maintenance or spare parts installation or replacement is required on a particular machine tool, instruction data can be transmitted to the man-machine interface of the machine tool, indicating or instructing how the required maintenance or the required spare parts installation or replacement can be carried out on the machine tool. This instructional data may comprise text, image, audio and/or video data indicating, showing or guiding one or more steps of the required maintenance, replacement parts installation or replacement. Such instruction data can, for example, be output or is displayable via a monitor of the control or operating panel of the machine tool.

The above aspects make it possible, on the one hand, to display or indicate in an advantageous way machine states and, on the other hand, to display, plot or evaluate a history of sensor signals or sensor system data on the machine tool as a function of time (time profile). This allows an advantageous efficient detection of problem areas. Furthermore, the collected sensor system data and further information about the machine state over time can be used advantageously for predictions. For example, it is possible to display a degree of wear of individual components and ultimately the remaining service life to be expected. This can be considered e.g. for pure consumables (e.g. lubricant tanks) on the basis of filling levels. In addition, additional sensor packages (e.g. quality sensors or special sensors for condition monitoring) can be offered to upgrade the existing sensor data of the machine tool with additional sensor data.

According to the invention, a data storage apparatus for use on a numerically controlled machine tool is proposed in embodiments, on which a status display on the basis of the collected sensor system data, a plotter function for displaying a time course of one or more sensor signals, a process analysis (e.g. search for events, e.g. excessive limit value rises of one or several sensor signals) on the basis of sensor system data collected over a predetermined period of time, a history-based program analysis and/or predictions for maintenance or spare parts replacement requirements, e.g. on the basis of filling level indicator-based and/or counter-based residual life time predictions for components and parts of the machine tools as well as required consumables (e.g. filter change, cooling lubricant change or necessary refills for consumables) on the basis of automated analyses of the collected sensor system data. In addition, NC program certification or machining process certification can also be carried out efficiently together with the storage of sensor system data, as desired in the aerospace or automotive sectors, for example, or as required according to process specifications.

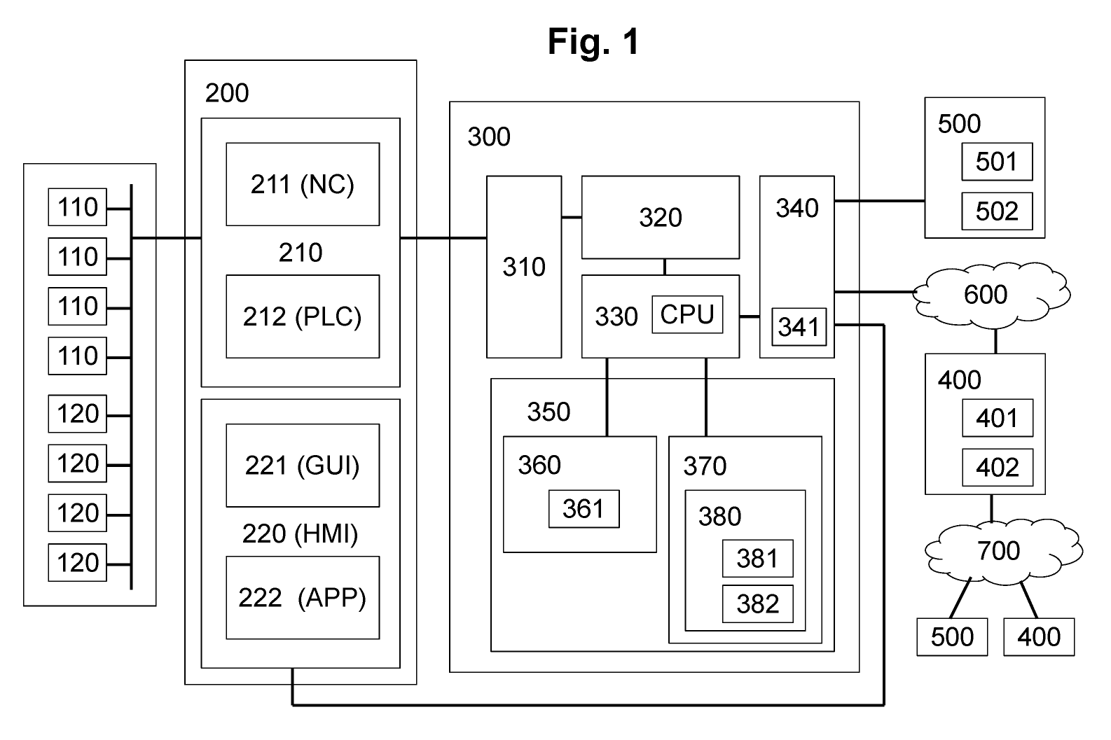

FIG. 1 shows an exemplary schematic diagram of a system with a data storage apparatus according to an embodiment of the invention.

The system comprises the data storage apparatus 300, a machine tool 100, a control device 200 of the machine tool 100 and an optional external data processing device 400.

The machine tool 100, for example, comprises a plurality of actuators 110 of the machine tool 100 that can be controlled by the control device 200 and a plurality of sensors 120 for sending sensor signals indicating a machine state of the machine tool 100 to the control device 200.

The actuators 110 can comprise, for example, drives of controllable linear and rotary axes (swivel and/or rotary axes) for a controlled relative movement between tool and workpiece, and also drives of tool-carrying work spindles (e.g. on milling machines) or workpiece-carrying work spindles (e.g. on lathes). Furthermore, the actuators 110 can be electronically, hydraulically and/or pneumatically controlled valves, pumps or other supply devices from internal or external coolant supply or compressed air supply systems. Conveyor devices, pallet changers, workpiece changers, tool magazines and other machine tool accessories can also be controlled via drives or circuits or corresponding actuators.

The sensors 120, for example, can be sensors that can be assigned to respective assemblies or components of the machine tool, e.g. the axles, the drives, the axle bearings, the spindles, the spindle bearings, a tool magazine, a tool changer, a pallet or workpiece changer, an internal or external coolant supply device, a chip conveyor device, and/or a hydraulic and/or pneumatic control system. For example, a variety of different sensors can be provided for the individual modules, such as position measuring sensors, current and/or voltage measuring sensors, temperature sensors, force sensors, acceleration sensors, vibration sensors, bearing diagnosis sensors, displacement sensors, filling level display sensors, liquid sensors (e.g. for measuring pH values in cooling lubricant liquids, water content measuring sensors for oil, coolant etc.), water content sensors in pneumatic systems, and/or filter condition sensors.

The sensors available on the machine tool and the availability of the sensor values on the controller can here vary greatly depending on the type of machine and/or controller.

For this purpose, the invention shall by way of example determine in a modifiable way in configuration data for reading out and processing the sensor data, which sensors are available or shall be read out on the machine tool and how the respective sensor values are read out (e.g. by defining predetermined individual read-out rates) and/or how the read-out sensor values shall be processed and stored (processing rules).

On the basis of the individually configurable configuration data, the data storage unit according to the invention can be used in a variety of ways and can be used on machines with an extensive sensor package having a large number of optional sensors, but can also be retrofitted to existing machines since, depending on the type and number of sensors available and control-dependent readout options, the configuration data allows the readout function and further processing function of the data storage unit to be configured in such a way that it is individually adapted to the respective machine and its control system or to the demand, while the sensor system data can still be transferred to other data processing devices via a universal interface (e.g. OPC interface, or in particular OPC UA interface) independent of the machine and controller.

The configuration data can, for example, be stored in a configuration file in a universal data format in a markup language (e.g. as an XML file).

The control device 200 includes e.g. a controller 210 with an NC control 211 and a programmable logic control 212 (also called PLC for “Programmable Logic Control”).

The control unit 200 also comprises, for example, a human-machine interface 220 (also called HMI for “human-machine interface”), which allows an operator of the machine tool 100 to control, monitor and/or operate the machine tool 100. The man-machine interface 220 comprises e.g. a graphical user interface 221 (also called GUI for “Graphical User Interface”) that can be displayed on a monitor or touch screen.

The data storage apparatus 300 comprises e.g. a first interface unit 310 (control interface), a read-out unit 320, an exemplary processor-controlled data processing unit 330, a second interface unit 340 (universal interface), and a data memory 350 with a first storage medium 360 and a second storage medium 370.

The first storage medium 360 (e.g. a memory, RAM, a hard disk or a flash memory) stores e.g. configuration data 361, which specifies a group of sensors 120 of the machine tool 100 and read-out and processing rules for sensor signals of the group of sensors 120 of the machine tool 100, and the second storage medium 370 (e.g. one or more hard disks and/or flash memories) comprises e.g. a database 380 for storing sensor system data 381 and certification data 382.

The read-out unit 320 is configured, for example, to read sensor signal values of the sensor signals of the group of sensors 120 of the machine tool 110 specified in the configuration data from control device 210 (e.g. from registers of PLC 212) via the first interface unit 310, in particular, for example, on the basis of the read-out rules specified in the configuration data.
The data processing unit 330 is configured, for example, to process the sensor signal values read out by the read-out unit into aggregated sensor system data, in particular, for example, on the basis of the processing rules specified in the configuration data, and to store the processed aggregated sensor system data 361 in the second storage medium 370 of the database 380.
The second interface unit 340 is configured, for example, for data transmission with an external data processing device, via which the external data processing device can access sensor system data 380 stored in the second storage medium 370.

As an example of such external data processing devices, FIG. 1 shows by way of example that the second interface unit 340 is connected to the man-machine interface 220 of the control unit 200 in such a way that e.g. an operator can be displayed sensor system data 381 by means of an application 222 and the graphical user surface 221 of the man-machine interface 220 or can access the sensor system data 381 and/or can view or modify, where required, the configuration data 361 via the graphical user interface 221, e.g. to change or view the readout and/or processing rules. The group of sensors 120 to be read out can also be viewed or changed.

As another example of such external data processing devices, FIG. 1 shows e.g. that the second interface unit 340 is connected to a computer device 500 (e.g. an external PC, a notebook, a smartphone or a tablet), which comprises an application 502 and a web browser 501, that an operator can e.g. be displayed sensor system data 381 using application 502 (for example a web application) and/or the web browser 501 or can access the sensor system data 381 and/or view or, if necessary, modify the configuration data 361, e.g. to change or view the read-out and/or processing rules. The group of sensors 120 to be read out can also be viewed or changed. The first interface unit includes, for example, a web service application 341 corresponding to application 502 (which, as a service application or server application, can grant access to the web applications, e.g. applications 222 and/or 502).

As another example of such external data processing devices, FIG. 1 shows e.g. that the second interface unit 340 is connected via a local or global network 600 to a server 400 comprising a web service application 401 (e.g. analogous to the web service application 341). The server 400 can receive or be transmitted sensor system data 381 and also certification data 382 via the interface unit 340 and store them locally on the server 400 in a storage medium 402 (e.g. hard disks, flash memory, cloud memory, external storage arrays, etc.) (e.g. in larger data volumes if the storage medium 370 comprises a ring buffer for storing the sensor system data 381, and/or also for storing sensor system data 381 of several machine tools 100 the controllers 210 of which are each connected to a corresponding data storage device 300).

Another server 400 and/or another computer device 500 can be connected to the server 400 via another local or global network 700 (e.g. a LAN, WAN, an Intranet or the Internet).

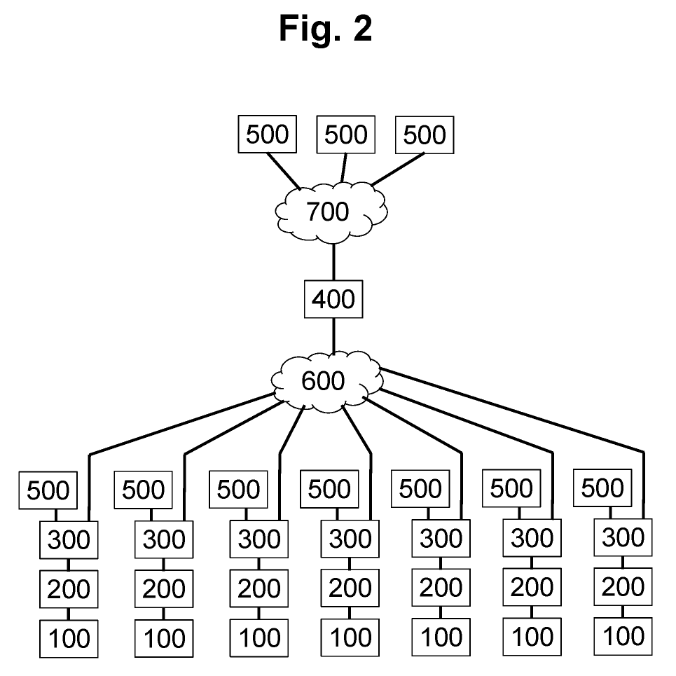

FIG. 2 shows an exemplary schematic diagram of a system according to another embodiment of the invention.

FIG. 2 shows an example of a plurality of machine tools 100 with respective control devices 200, which are also connected to a data storage device 300 in analogy to FIG. 1. For example, respective external data processing devices 500 (e.g. control PC, mini-PC, PC, notebook, tablet, smartphone) are connected to the data storage device 300 analogously to FIG. 1.

In addition, e.g. all data storage devices 300 are connected to a server 400 via a network 600 (e.g. a LAN, WAN, WLAN or Intranet) in order to transmit sensor system data 381 (and/or certification data 382) read-out, processed and stored or buffered in the respective data storage devices 300 at the controllers 200 of the respective machine tools 100 repeatedly, regularly or on request to the server 400.

The server 400 can thus store sensor system data 381 collected from several machine tools 100 centrally on a server 400. Via another network 700 (e.g. a LAN, WAN, WLAN, Intranet or the Internet, or alternatively via the same network 600), additional data processing devices 500 can access the data or sensor system data 381 and/or certification data 382 collected and stored on the server 400 to display, analyze or generate any maintenance or spare parts requirement forecasts. Data from different machine tools 100 can also be compared for analysis here.

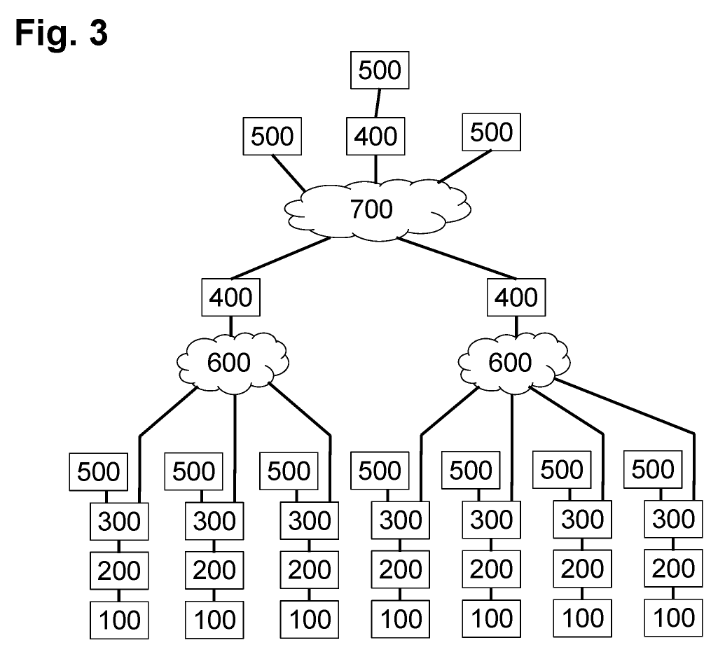

FIG. 3 shows an exemplary schematic diagram of a system according to another embodiment of the invention.

FIG. 3 shows an example of a first group of a plurality of machine tools 100 with respective control devices 200, which are also connected to a data storage device 300 analogous to FIG. 1, and a second group of a plurality of machine tools 100 with respective control devices 200, which are also connected to a data storage device 300 analogous to FIG. 1.

For example, external data processing devices 500 (e.g. control PC, mini-PC, PC, notebook, tablet, smartphone) are connected to the data storage devices 300 in the same way as FIG. 1.

In addition, for example, all data storage devices 300 of the first group are connected to a first server 400 (first local server) via a first network 600 (e.g. a LAN, WAN, WLAN or Intranet) in order to transmit in the respective data storage devices 300 at the controllers 200 of the respective machine tools 100 read-out, processed and stored or buffered sensor system data 381 (and/or certification data 382) repeatedly, regularly or on request to the first server 400.

The first server 400 can thus store sensor system data 381 collected from several machine tools 100 of the first group locally and centrally. Via another network 700 (e.g. a LAN, WAN, WLAN, Intranet or the Internet, or alternatively via the same network 600) the data can still be transferred to a second server 400 (central server) where it is stored in globally centralized fashion.

In addition, for example, all data storage devices 300 of the second group are connected to a third server 400 (second local server) via a second network 600 (e.g. a LAN, WAN, WLAN or Intranet) in order to transmit sensor system data 381 (and/or certification data 382) read-out, processed and stored or buffered in the respective data storage devices 300 at the controllers 200 of the respective machine tools 100 repeatedly, regularly or on request to the third server 400 (central server).

The third server 400 can thus store sensor system data 381 collected from several machine tools 100 of the second group locally and centrally. Via the further network 700 (e.g. a LAN, WAN, WLAN, Intranet or the Internet, or alternatively via the same network 600) the data can still be transferred to the second server 400 (central server) where it is stored in globally centralized fashion.

Therefore, the second server 400 can store all sensor system data and certification data of all machine tools of the first and second groups and make them available for display, analysis or comparison. The first and second groups can, for example, be machine tool groups that are set up in different workshops or at different locations or at different companies.

Via the network 700, additional data processing devices 500 can access the data or sensor system data 381 and/or certification data 382 collected and stored on the second server 400 to view, analyze or generate any maintenance or spare parts demand forecasts. Data from different machine tools 100 can also be compared for analysis here.

If the collected data on the server 400 (preferably on the central server 400) and/or the data processing device 500 is used to determine or predict that maintenance must be carried out on a machine tool 100, that a spare part must be installed or that components or processing equipment must be replaced, it can be possible to trigger an automatic ordering process in some embodiments, so that the required maintenance items and/or spare parts are delivered to the location of the respective machine tool 100 or the corresponding delivery process is automatically triggered.

If it is determined or predicted from the collected data on the server 400 or the data processing device 500 that maintenance is to be carried out on a machine tool 100, a spare part must be installed or components or processing means must be exchanged, instruction data can be transmitted in embodiments via the respective networks to the machine tool 100 or to its connected human-machine interface 220, which can be displayed via the graphical user interface 221 and indicate how the required maintenance and/or the required spare part installation or the required spare part replacement can be carried out on the machine tool 100.

The instruction data can include text data and/or image data indicating instructions for one or more steps for maintenance and/or installation of spare parts or replacement of spare parts on machine tool 100. The instruction data can also include audio and/or video data describing and/or showing one or more steps for maintenance and/or installation of spare parts or replacement of spare parts on the machine tool 100.

This has the advantage that maintenance personnel can be instructed directly at the machine tool or its man-machine interface by text, image, audio and/or video data to carry out the required maintenance and/or the required spare parts installation or replacement on the machine tool 100.

The examples and embodiment of the present invention and the advantages thereof are described in detail above with reference to the attached drawings. It should again be pointed out, however, that the present invention is in no way limited or restricted to the embodiments described above and the design features thereof but also includes modifications of the embodiments, in particular those which are covered by modifications to the features of the described examples or by combining one or more of the features of the described examples within the scope of protection of the independent claims.

In summary, a data storage apparatus is provided for use on a numerically controlled machine tool or embodiments of a data storage apparatus, which allows a simpler, clearer, easy-to-use storage of sensor system data of a numerically controlled machine tool, which is also capable of reducing the data processing utilization of the machine tool control when reading out the sensor values and can further reduce the amount of data to be stored while maintaining a high informative force, and which is also preferably universally applicable regardless of machine tool type and/or controller type.

1. A data storage apparatus for use with a numerically controlled machine tool, comprising a control device for controlling a plurality of actuators of the machine tool and a plurality of sensors for sending sensor signals indicating a machine state of the machine tool to the control device, wherein the data storage apparatus comprises:
a first interface unit for transmitting data with the numerical control device of the machine tool,
a first storage medium for storing configuration data indicating a group of machine tool sensors as well as read-out and processing rules for sensor signals of the group of sensors of the machine tool,
a read-out unit for reading out sensor signal values of the sensor signals of the group of sensors of the machine tool specified in the configuration data via the first interface unit on the basis of the read-out rules specified in the configuration data,
a data processing unit for processing the sensor signal values read out by the read-out unit into aggregated sensor system data on the basis of the processing rules specified in the configuration data,
a second storage medium for storing the aggregated sensor system data processed by the data processing unit, and
a second interface unit for transmitting data to an external data processing device via which the external data processing device can access sensor system data stored in the second storage medium.

2. The data storage apparatus according to claim 1, wherein
the second interface unit is configured to transmit sensor system data stored in the second storage medium to a server via a local or global network.

3. The data storage apparatus according to claim 2, wherein
the data processing unit is configured to compress and/or encrypt the sensor system data stored in the second storage medium for transmitting data to the server.

4. The data storage apparatus according to claim 1, wherein
the second interface unit comprises a web interface and/or a web service application via which the external data processing device can access aggregated sensor system data stored in the second storage medium by means of a web browser and/or a web application.

5. The data storage apparatus according to claim 1, wherein
the configuration data also specifies a data format, and the data processing unit is configured to store the aggregated sensor system data in the data format specified in the configuration data in the second storage medium.

6. The data storage apparatus according to claim 1, wherein
the second interface unit can be connected to a man-machine interface of the control device of the machine tool for transmitting sensor system data stored in the second storage medium to the man-machine interface for display on a graphical user surface of the man-machine interface of the control device of the machine tool.

7. The data storage device according to claim 1, wherein
the second storage medium comprises a ring buffer and the sensor system data is stored in the ring buffer.

8. The data storage apparatus according to claim 1, wherein
the read-out rules of the configuration data for one, several or all sensor signals of the group of sensors of the machine tool specified in the configuration data indicate an individual read-out frequency, and
the read-out unit is configured to read out sensor signal values for a corresponding sensor signal at the corresponding individual read-out frequency specified in the configuration data,
wherein at least one individual read-out frequency specified in the configuration data is lower than a sensor value memory frequency of a programmable logic controller and/or than a sensor value memory frequency of an NC control of the control device.

9. The data storage apparatus according to claim 1, wherein
the processing rules of the configuration data specify an individual processing rule for one, several or all sensor signals of the group of sensors of the machine tool specified in the configuration data, and
the data processing unit is configured to calculate a single sensor system value for a corresponding sensor signal from a plurality of sensor signal values read out over a period of time specified in the individual processing rule on the basis of the corresponding individual processing rule specified in the configuration data and to store it in the second storage medium,
wherein the individual processing rule specifies that the sensor system value is to be calculated as the average value of the plurality of sensor signal values read out over a period of time specified in the individual processing rule, or the individual processing rule specifies that the sensor system value is to be calculated as the maximum value or minimum value of the plurality of sensor signal values read out over a period of time specified in the individual processing rule.

10. The data storage apparatus according to claim 1, wherein
the processing rules of the configuration data specify a combination rule for at least two sensor signals of the group of sensors of the machine tool specified in the configuration data, and
the data processing unit is configured to calculate a combined sensor system value for sensor values of the at least two sensor signals on the basis of the combination rule and to store it in the second storage medium.

11. The data storage apparatus according to claim 1, wherein
the configuration data comprises certification rules for one, several or all sensor signals of the group of machine tool sensors specified in the configuration data, and
the data processing unit is also configured to generate certification data on the basis of the certification rules specified in the configuration data and on the basis of the corresponding read-out sensor signals, and to store the generated certification data in the second storage medium,
wherein the second interface unit of the external data processing device allows access to certification data stored in the second storage medium.

12. The data storage apparatus according to claim 1, wherein
the second interface unit is configured to grant the external data processing device access to configuration data stored in the first storage medium for modifying the configuration data.

13. The data storage apparatus according to claim 1, wherein
the configuration data for one, several or all sensor signals of the group of sensors of the machine tool specified in the configuration data specify one or several individual limit values, and
the data processing unit is configured to store associated limit values specified in the configuration data in the second storage medium for calculated sensor system values.

14. The data storage apparatus according to claim 1, wherein
the read-out unit is also configured to read out counter reading values from registers of a programmable logic controller of the control device of the machine tool via the first interface unit, and
the data processing unit is also configured to store read-out counter reading values together with a time stamp in the sensor data in the second storage medium.

15. A system comprising a data storage device according to claim 1 and an external data processing device connected to the second interface unit via a local or global network and configured to access sensor system data stored in the second storage medium and/or configuration data stored in the first storage medium via the second interface unit.
